(19) United States
(12) Patent Application Publication
(10) Pub. No.: US 2002/0071055 A1
(43) Pub. Date: Jun. 13, 2002

(54) Display apparatus and method

(76) Inventors: Junichi Ooshima, Kanagawa (JP); Shigemi Sakamoto, Chiba (JP)

Correspondence Address: William S. Frommer, Esq., FROMMER LAWRENCE & HAUG LLP, 745 Fifth Avenue, New York, NY, 10151, US

(21) Appl. No.: 09/996,044

(22) Filed: Nov. 28, 2001

(30) Foreign Application Priority Data
Nov. 30, 2000 (JP) 2000-365673

(51) Int. Cl. H04N 7/00

(52) U.S. Cl. 348/552

(57) ABSTRACT

Disclosed is a display apparatus wherein a TV display picture received by a TV tuner in the display apparatus can be manipulated by an external electronic appliance such as a personal computer connected thereto. The video signal of the TV picture received by the display apparatus via an antenna is compressed and transmitted to the personal computer via a USB cable. Then the compressed TV-picture video signal received from the display apparatus is expanded in the personal computer, and a video signal is generated by superposing the TV picture on the display picture being controlled by the personal computer. The new video signal thus generated is transferred to the display apparatus via an RGB cable, and subsequently there is displayed, on the display apparatus, the video signal transferred thereto from the personal computer.

### BACKGROUND OF THE INVENTION

The present invention relates to a display apparatus, a display method and a recording medium, and more particularly to those adapted for enabling an external electronic appliance to process a TV (television) picture displayed on the display apparatus equipped with a TV tuner.

There is recently diffused in general use the technology that a TV tuner is employed for a display apparatus used in a personal computer and a TV picture is superposed on another picture being displayed by the personal computer.

In the conventional display apparatus equipped with a TV tuner and designed originally for use in a personal computer, it has been customary heretofore that a video image received by the TV tuner is superposed, in the display apparatus, on the display picture transferred from the personal computer, and then is displayed on its display unit. Such display is generally termed “picture-in-picture” where a window of a TV picture is displayed on the picture being displayed by the personal computer.

In the TV picture displayed on the display unit, it is possible for a user to select either a display mode or a non-display mode and to specify the size and position thereof by manipulating an operation menu represented visually on the display unit.

However, in the structure mentioned above, the TV picture is superposed on the personal-computer picture inside the display apparatus, so that the manipulation for specifying the position or size of the TV picture on the display unit always needs to use the operation menu on the display unit, hence raising a problem that, although the display apparatus is designed originally for use in the personal computer, it is impossible to perform the manipulation from the personal computer.

Further, since the TV picture is processed in the display apparatus, the video signal of the TV picture is not outputted to the personal computer, and consequently there arises another problem that the processes of recording and reproducing the TV picture cannot be executed by the personal computer.

### SUMMARY OF THE INVENTION

The present invention has been accomplished in view of the circumstances mentioned above. And it is an object of the invention to enable an external electronic appliance to manipulate display of a TV picture represented visually by a display apparatus having a TV tuner.

According to a first aspect of the present invention, there is provided a display apparatus which includes compression means for compressing a video signal generated by a demodulator, and transfer means for transferring the compressed video signal from the compression means to another electronic appliance via a bus.

In the above display apparatus, the bus may be a USB cable, or an IEEE1394 serial bus.

The display apparatus may further includes expansion means for expanding the compressed video signal, wherein the expansion means expands the compressed video signal inputted thereto via a bus from another electronic appliance.

According to a second aspect of the present invention, there is provided a display method which includes a compression step of compressing a video signal generated by a demodulator, and a transfer step of transferring such compressed video signal to another electronic appliance via a bus.

And according to a third aspect of the present invention, there is provided a recording medium containing a program which includes a compression control step of controlling the compression of a video signal generated by a demodulator, and a transfer control step of controlling the transfer of the compressed video signal executed via the bus to another electronic appliance.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a schematic diagram showing the structure of an embodiment which represents a personal computer system where the present invention is applied;

FIG. 2 is a block diagram showing the structure of a display apparatus employed in FIG. 1;

FIG. 3 is a block diagram showing the structure of a personal computer employed in FIG. 1;

FIG. 4 is a flowchart for explaining a processing routine of receiving and displaying a video signal by the display apparatus;

FIG. 5 is a flowchart for explaining a processing routine of recording a video signal by the personal computer;

FIG. 6 is a flowchart for explaining a processing routine of transferring the video signal by the personal computer; and

FIG. 7 is a flowchart for explaining a processing routine of displaying an external input of the video signal by the display apparatus.

### DESCRIPTION OF THE PREFERRED EMBODIMENTS

Hereinafter some preferred embodiments of the present invention will be described in detail with reference to the accompanying drawings.

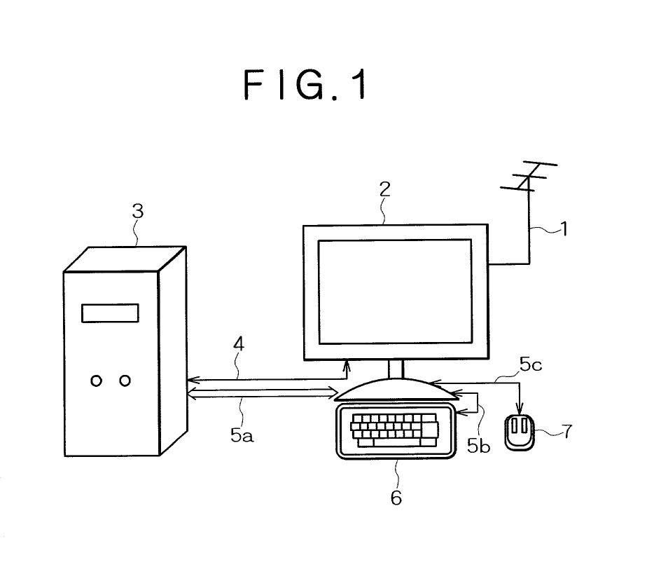

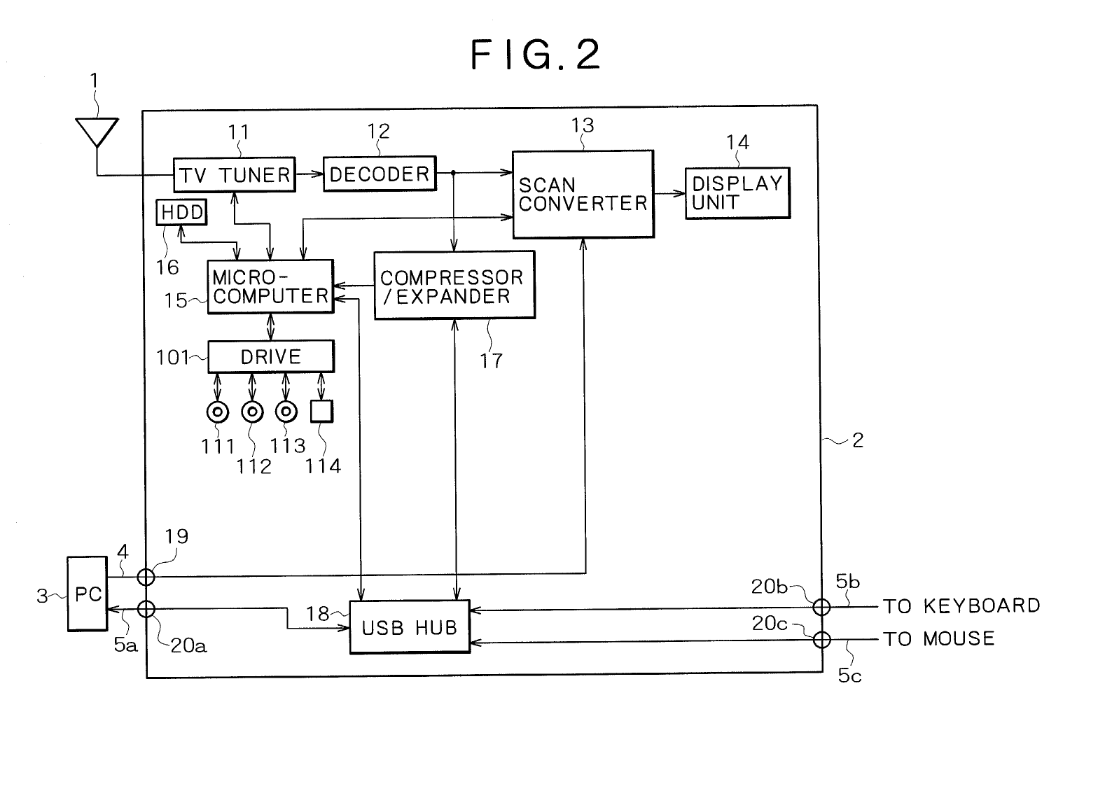

FIG. 1 is a schematic diagram showing the structure of a preferred embodiment which represents a personal computer system where the present invention is applied. A display apparatus 2 receives a video image (TV picture) of broadcast signal obtained by a TV tuner 11 (FIG. 2) via an antenna 1, and displays such a TV picture in another picture processed by a personal computer 3. An RGB (red-green-blue) cable 4 is actually an exclusive video transfer cable composed of three red, green and blue cables, and transfers the video signals outputted from the personal computer 3 to the display apparatus 2 at a maximum transfer rate of 270 Mbps.

A USB (universal serial bus) cable 5a is used for transmitting and receiving data bidirectionally between the personal computer 3 and the display apparatus 2. The USB is based on common standards for connection of various peripheral devices such as keyboard, mouse, joystick, modem and printer, in which its maximum communication rate is 12 Mbps. The USB is a capable of connecting a maximum of 127 various devices through a single terminal, and is furnished with a function termed a hot plug which realizes connection and disconnection without the necessity of switching off the power.

A USB cable 5b connects the display apparatus 2 to the keyboard 6, and a USB cable 5c connects the display apparatus 2 to the mouse 7, wherein the manipulation information of the keyboard 6 and the mouse 7 is transferred respectively to the personal computer 3 via the display apparatus 2. In the following description, the USB cables 5a to 5c will be referred to simply as a USB cable 5 when individual distinction is not necessary.

Next, the structure of the display apparatus 2 will be explained below with reference to FIG. 2.

The TV tuner 11 in the display apparatus 2, which is under control of a microcomputer 15, demodulates the broadcast signal of a predetermined frequency received by the antenna 1 and outputs the demodulated signal to a decoder 12. Then the decoder 12 decodes the input signal obtained from the TV tuner 11 to thereby generate video and audio signals, and outputs such signals to a compressor/expander 17 while outputting the video signal to a scan converter 13 and the audio signal to an unshown speaker.

Subsequently the scan converter 13 converts the various numbers of scanning lines of the video signal, which is inputted from either the decoder 12 or an RGB terminal 19, into the predetermined number of scanning lines adapted to be displayed on a display unit 14, and then outputs the converted signal to the display unit 14. The display unit 14 consists of an LCD (liquid crystal display) or a CRT (cathode ray tube), and serves to display thereon the video signal inputted from the scan converter 13.

The microcomputer 15 includes a CPU (central processing unit), a ROM (read only memory) and a RAM (random access memory), and controls the entire operation of the display apparatus 2. The microcomputer 15 reads out data or a program recorded in an HDD (hard disk drive) 16, or in a magnetic disk 111, an optical disk 112, a magneto-optical disk 113 or a semiconductor memory 114 provided in a drive 101, and executes its operation.

The compressor/expander 17 compresses the video and audio signals, which are inputted from the decoder 12, into a predetermined format conforming with the MPEG (Moving Picture Experts Group) standards or the like, and then outputs the video signal to the personal computer 3 via a USB hub 18, a USB terminal 20a and the USB cable 5a. Further the compressor/expander 17 expands the compressed video and audio signals inputted from the personal computer 3 via the USB cable 5a, the USB terminal 20a and the USB hub 18, and then outputs the expanded signals to the scan converter 13.

The USB hub 18 is a kind of distributor corresponding to the USB cable 5. In this case, the USB hub 18 transfers the manipulation information of the keyboard 6 via the USB cable 5b and the USB terminal 20b, or transfers the manipulation information of the mouse 7 via the USB cable 5c and the USB terminal 20c, or via the USB terminal 20a and the USB cable 5a to the personal computer 3; or transfers the compressed video and audio signals, which are transferred thereto from the personal computer 3 via the USB cable 5a and the USB terminal 20a, to the compressor/expander 17; or transfers the compressed video and audio signals, which are transferred thereto from the compressor/expander 17, to the personal computer 3 via the USB terminal 20a and the USB cable 5a.

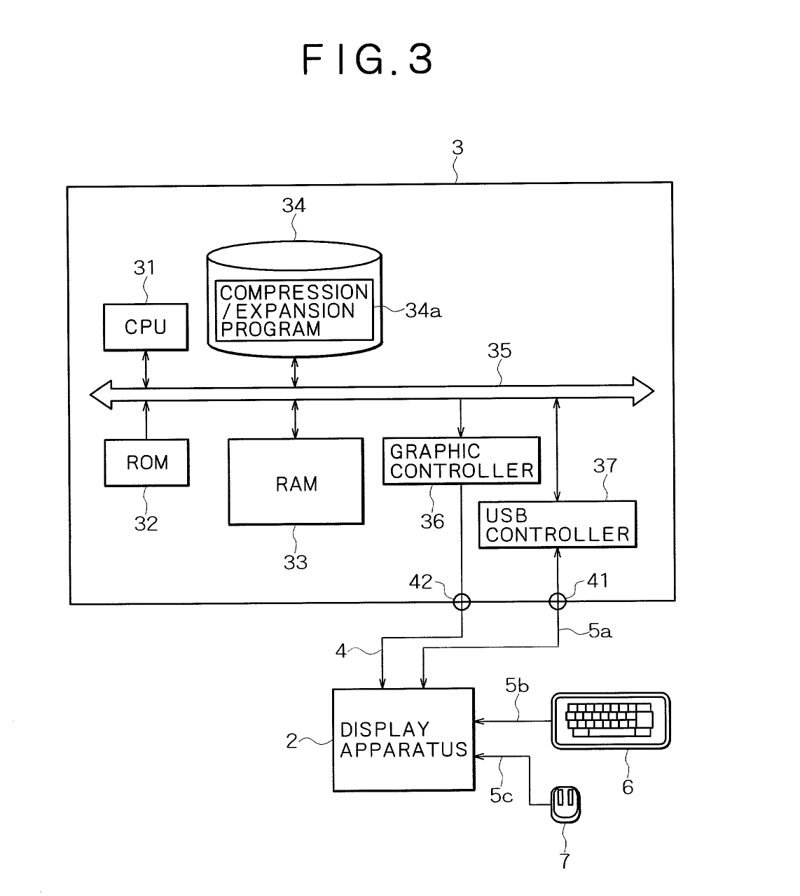

Referring now to FIG. 3, an explanation will be given on the structure of the personal computer 3.

A CPU 31 controls the entire operation of the personal computer 3, and loads the program, which is stored in a ROM 32 connected thereto via a main bus 35, into a RAM 33 and then executes the program. The CPU 31 also executes various programs stored in an HDD 34, and further serves to record the compressed video and audio signals transferred from the display apparatus 2 via the USB cable 5a, a USB terminal 41 and a USB controller 37. Moreover, the CPU 31 reads out the compressed video and audio signals recorded in the HDD 34, then executes a compression/expansion program 34a to expand the signals, and superposes the same on a display picture controlled by the personal computer 3, thereby generating a video signal of a new picture. Subsequently the CPU 31 outputs the generated video signal to the display apparatus 2 via a graphic controller 36, an RGB terminal 42 and an RGB cable 4, while outputting the audio signal to an unshown speaker.

Further the CPU 31 outputs the compressed video and audio signals, which are recorded in the HDD 34, to the display apparatus 2 via the USB terminal 41 and the USB cable 5a. Moreover, the CPU 31 processes the manipulation information of the keyboard 6 or the mouse 7 inputted thereto via the USB terminal 20a of the display apparatus 2 and the USB cable 5a, or via the USB terminal 41 of the personal computer 3 and the USB controller 37, thereby generating a corresponding display picture, and outputs the picture to the display apparatus 2 via the RGB terminal 42 and the RGB cable 4; or compresses the video signal of the display picture thus generated and the audio signal corresponding thereto in accordance with a compression/expansion program 34a, and then outputs the compressed signals to the display apparatus 2 via the USB controller 37, the USB terminal 41 and the USB cable 5a.

More specifically, the CPU 31 transfers the video signal of the generated display picture (where the TV picture is superposed on the display picture controlled by the personal computer 3) to the display apparatus 2 via the RGB cable 4 or the USB cable 5a. Regarding the transfer of the generated display picture to the display apparatus 2 via either the RGB cable 4 or the USB cable 5a may be specified, with respect to the priority order, by the user through manipulation of the keyboard 6 or the mouse 7.

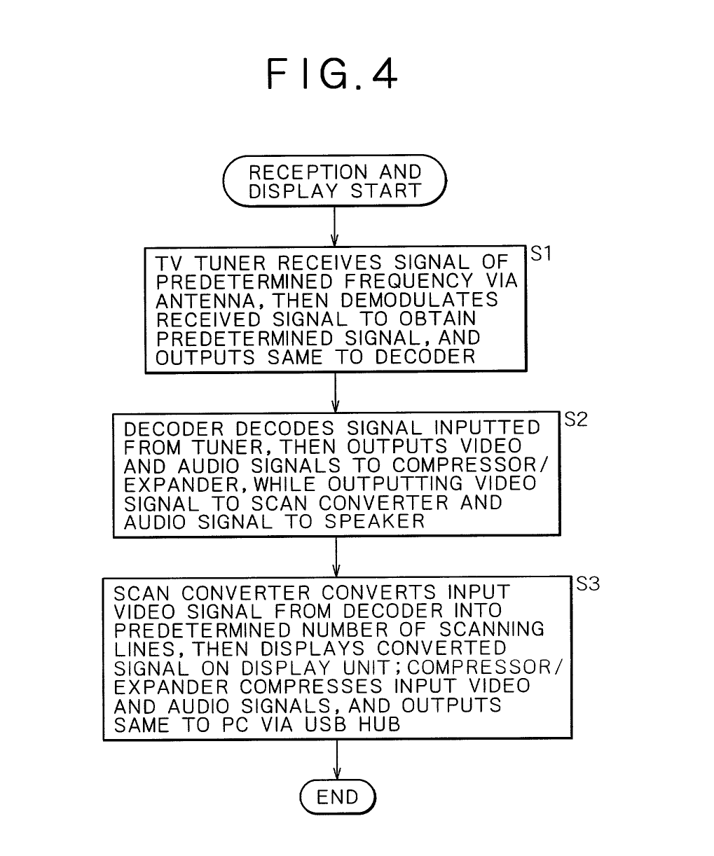

Next, a processing routine of demodulating and displaying broadcast signals received by the display apparatus 2 via the antenna 1 will be described below with reference to a flowchart of FIG. 4.

At step S1, the TV tuner 11 receives, via the antenna 1, broadcast signal of a frequency specified by the microcomputer 15, then demodulates the received signal to obtain a predetermined signal, and outputs the same to the decoder 12. At step S2, the decoder 12 decodes the demodulated signal to thereby generate video and audio signals, and sends the same to the compressor/expander 17, while outputting the video signal to the scan converter 13 and the audio signal to an unshown speaker.

At step S3, the scan converter 13 converts the input video signal obtained from the decoder 12 into a video signal of a predetermined number of scanning lines adapted to be displayed on the display unit 14, whereby the signal is displayed thereon. At this time, the compressor/expander 17 compresses the video and audio signals inputted from the decoder 12, and then sends the compressed signals to the personal computer 3 via the USB hub 18 and the USB terminal 20a.

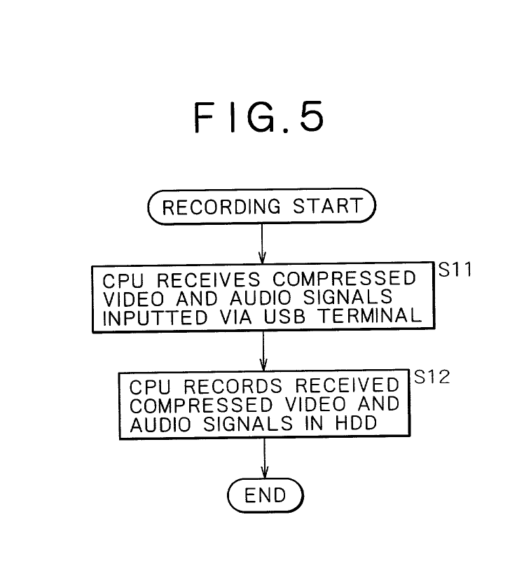

Next, referring to a flowchart of FIG. 5, an explanation will be given on a processing routine of recording the compressed video and audio signals when the personal computer 3 has received the input compressed video and audio signals on the basis of the process executed by the display apparatus 2.

At step S11, the CPU 31 receives the compressed video and audio signals inputted from the display apparatus 2 via the USB terminal 41 and the USB controller 37. And at step S12, the CPU 31 records the received compressed video and audio signals in the HDD 34.

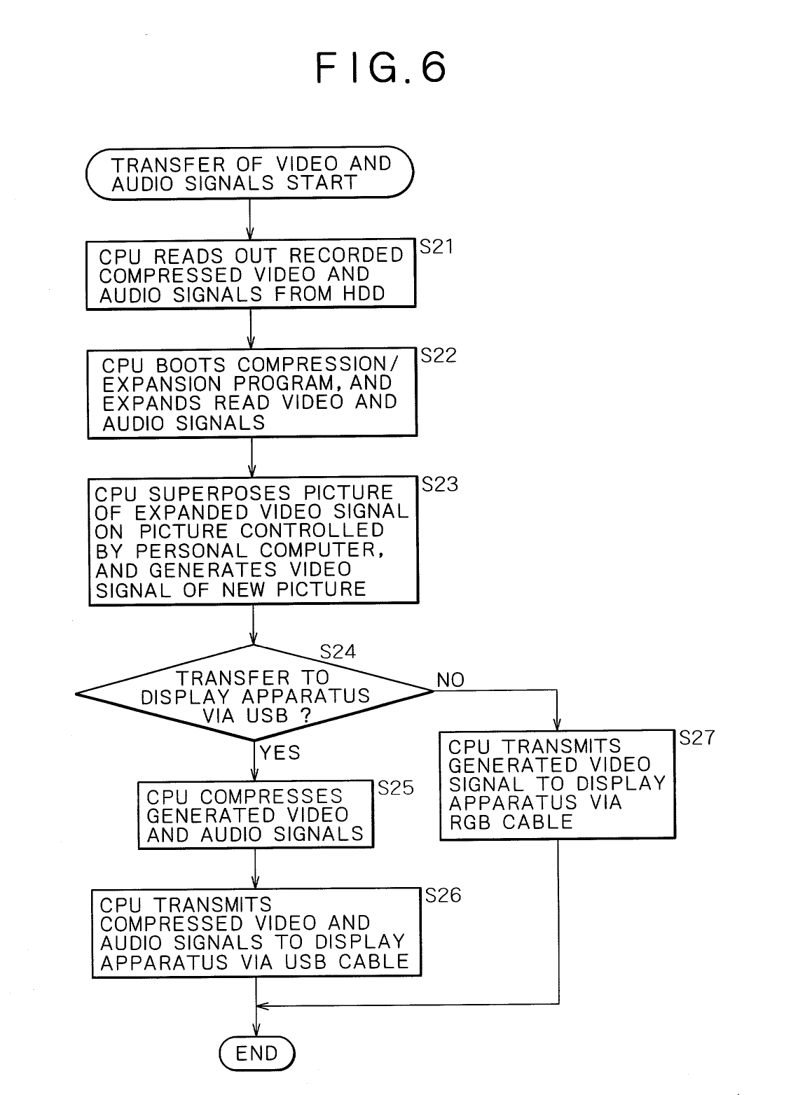

Referring now to a flowchart of FIG. 6, an explanation will be given on a processing routine executed when the personal computer 3 transfers the compressed video and audio signals to the display apparatus 2 after superposing the compressed video signal recorded in the HDD 34 on the display picture being controlled by the personal computer 3 itself.

At step S21, the CPU 31 reads out the compressed video and audio signals recorded in the HDD 34. At step S22, the CPU 31 boots up the compression/expansion program 34a to expand the compressed video and audio signals thus read out. Subsequently at step S23, the CPU 31 generates a video signal of a new picture where the picture of the expanded video signal is superposed on the display picture being controlled by the personal computer 3.

Thereafter at step S24, the CPU 31 makes a decision as to whether to transfer the generated video signal via the USB terminal 41 or not. That is, the path for transferring the video signal from the personal computer 3 to the display apparatus 2 is either the USB terminal 41 or the RGB terminal 42. Therefore, in the CPU 31, a decision is made to select one of these terminals as a path for transferring the signal.

For example, in case the USB terminal 41 is selectively set as a transfer path, the CPU 31 compresses, at step S25, the generated video and audio signals in accordance with the compression/expansion program 34a.

And at step S26, the CPU 31 transfers the compressed video and audio signals to the display apparatus 2 via the USB controller 37, the USB terminal 41 and the USB cable 5a.

If the result of the decision at step S24 signifies no transfer of the video signal via the USB terminal 41, i.e., in case the RGB terminal 42 is selectively set as a path for transferring the video signal, the CPU 31 sends, at step S27, the generated video signal to the display apparatus 2 without any processing via the graphic controller 36, the RGB terminal 42 and the RGB cable 4.

In transferring the video signal to the display apparatus via the RGB cable 4, the audio signal is either outputted to an unshown speaker provided in the personal computer 3, or is transferred to the display apparatus 2 via an unshown cable.

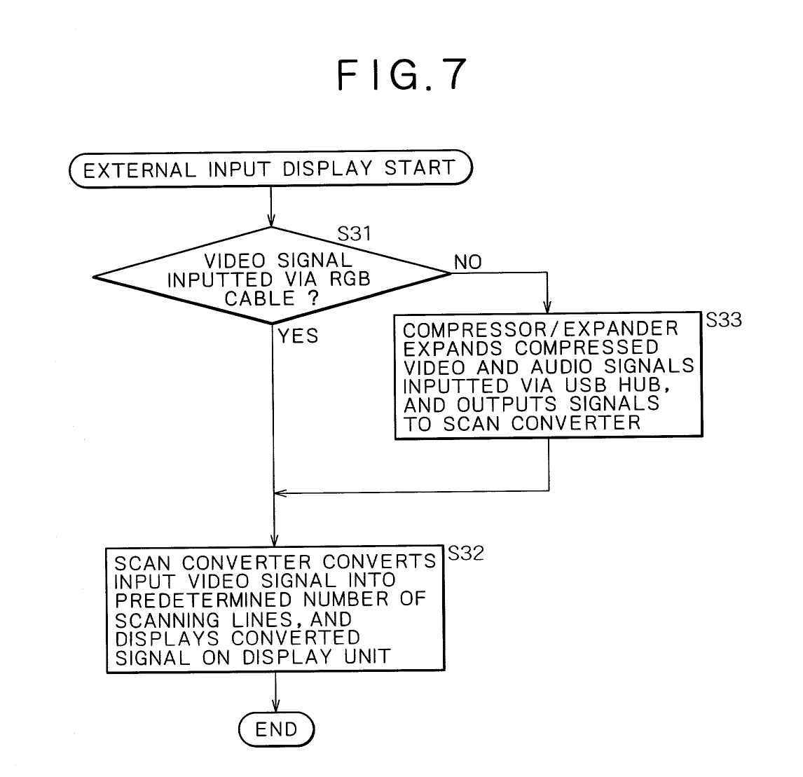

Referring now to a flowchart of FIG. 7, an explanation will be given on a processing routine executed by the display apparatus 2 for displaying the video signal transferred thereto from the personal computer 3.

At step S31, the microcomputer 15 makes a decision as to whether the video signal has been inputted or not via the RGB terminal 19. And if the result of this decision is affirmative to signify that the video signal has been inputted via the RGB terminal 19, the operation proceeds to step S32.

Subsequently at step S32, the scan converter 13 converts the input video signal into a predetermined number of scanning lines adapted to be displayed on the display unit 14, and then the display unit 14 displays a picture thereon where a TV display picture controllable by the personal computer 3 is superposed.

On the other hand, if the result of the decision at step S31 is negative to signify that the video signal has not been inputted via the RGB terminal 19, i.e., the compressed video signal has been inputted via the USB terminal 20a, then the microcomputer 15 controls the compressor/expander 17 at step S33 to expand the input compressed video signal and sends the same to the scan converter 13. Thereafter the operation proceeds to step S32.

In the above-described flowcharts of FIGS. 4 to 7, the explanation has been given on an exemplary case where the personal computer 3 stores, in the HDD 34, the TV picture outputted from the display apparatus 2, then the video signal stored in the HDD 34 is superposed on the display picture controlled by the personal computer 3, and subsequently the composite picture generated by superposing the TV picture is transferred to the display apparatus 2 so as to be displayed thereon. However, the TV picture outputted from the display apparatus 2 may be displayed in real time on the display apparatus 2 without being once stored in the HDD 34. In this case, the operation may proceed to step S23 in FIG. 6 after completion of the process at step S11 in FIG. 5. Further, the TV picture may be recorded simultaneously with being displayed in real time on the display apparatus 2.

Thus, since the display apparatus 2 compresses the video signal of the received TV picture by the compressor/expander 17 in the manner described, it is possible to transfer the video signal of the TV picture to the personal computer 3 by means of the USB cable 5 or the like of a low transfer rate (maximum 12 Mbps), instead of using the RGB cable 4 or the like of a high transfer rate (maximum 270 Mbps).

Upon reception of the compressed video signal from the display apparatus 2, the personal computer 3 expands the input signal and superposes the same on the picture controlled by the personal computer 3 itself, thereby producing the composite video signal. And then the personal computer 3 transfers the composite video signal to the display apparatus 2 again for displaying the same. For this reason, when the personal computer 3 superposes the TV picture on the display picture controlled by the personal computer 3, it becomes possible to selectively switch either a display mode or a non-display mode relative to the TV picture represented on the display unit 14 or to control the position and size of the picture. Further, the personal computer 3 is capable of storing the TV-picture video signal in the HDD 34 merely by installing software such as the compression/expansion program 34a. Moreover, by the application of a similar technique, the personal computer 3 is capable of storing, in the HDD 34, graphic information or text information such as EPG (electric program guide) or character broadcast included in the vertical blanking interval of the video signal.

The embodiment mentioned above represents an example where the display apparatus 2, the personal computer 3, the keyboard 6 and the mouse 7 are connected mutually by using the USB cable 5. However, any other cable may also be used as well, such as IEEE (Institute of Electrical and Electronic Engineers) 1394 serial bus.

The explanation given hereinabove is concerned with an exemplary case of receiving wireless broadcast signals by the antenna 1. However, the signals are not limited to such wireless broadcast signals alone, and a cable television program transmitted for example via a cable may be received and displayed. In another example, a terminal may be provided in a stage posterior to the decoder 12 in the display apparatus 2, wherein an output video signal from a video recording/reproducing apparatus or the like is supplied so that any video image recorded in another recording medium can be controlled by the personal computer 3.

The video signal compression/expansion method may be based on any other standard than the MPEG, such as AVI (Audio Video Interleaving), Motion JPEG (Motion Joint Photographic Experts Group) or the like contrived for compression.

Due to the structure of the display apparatus 2 and the personal computer 3, the video signal can be transferred via the USB cable 5a alone between the personal computer 3 and the display apparatus 2, so that it becomes possible to eliminate the necessity of the RGB cable 4, hence realizing simpler connection between the display apparatus 2 and the personal computer 3 via the USB cable 5 only. Further, the process executed at step S24 in FIG. 6 may be so modified that the CPU 31 makes a decision as to whether the RGB cable 4 is connected to the RGB terminal 42 or not, and if the result of this decision is affirmative to signify that the RGB cable 4 is connected, the generated display-picture video signal is transmitted to the display apparatus 2 via the RGB cable 4; meanwhile, if the result of the decision is negative to signify that the RGB cable 4 is not connected, the video signal is transferred to the display apparatus 2 via the USB cable 5. In this modification, when the display apparatus 2 is connected via the RGB cable 4, the compression/expansion program 34a need not be executed to consequently reduce the load processed by the CPU 31.

Thus, according to the above embodiment, the compressor/expander 17 is provided in the display apparatus 2 for compressing and transferring the TV-picture video signal to the personal computer 3, wherein the compressed video signal is transferred via the USB cable 5a to the personal computer 3, which then expands the compressed video signal and generates a new display picture by superposing the expanded video signal on the display picture controlled by the personal computer 3 itself, so that the display picture thus generated can be transferred to the display apparatus 2 via the RGB cable 4 to be thereby displayed. Consequently, it is rendered possible for an external electronic appliance such as the personal computer 3 to manipulate the TV picture represented on the display apparatus 2.

The processing routine mentioned above is executable by software as well as by hardware. For execution of the routine by software, such software can be installed from a recording medium into, e.g., a computer where programs constituting the relevant software are incorporated in its exclusive hardware, or into a general-purpose personal computer which is capable of executing various functions in accordance with various programs installed therein.

This recording medium is not limited merely to the program-recorded HDD 16 provided for users in a state incorporated previously in the display apparatus 2 as shown in FIG. 2, and it may be a package one distributed to provide programs for users separately from the display apparatus 2, including a magnetic disk 111 (including floppy disk), an optical disk 112 (including CD-ROM (compact disk-read only memory)) and a DVD (digital versatile disk)); a magneto-optical disk 113 (including MD (Mini-Disk)), or a semiconductor memory 114 (including Memory Stick) where programs are recorded.

In this specification, the steps that describe the program stored in the recording medium are executed in time series in accordance with the mentioned sequence, or may be executed in parallel or individually without being restricted to the time series processing.

Also in this specification, a term “system” connotes the whole equipment including a plurality of apparatus and devices.

While a preferred embodiment of the present invention has been described using specific terms, such description is for illustrative purposes only, and it is to be understood that changes and variations may be made without departing from the spirit or scope of the following claims.

What is claimed is:

1. A display apparatus having a video signal input terminal for inputting a video signal from another electronic appliance; a receiver for receiving a broadcast signal; a demodulator for demodulating the broadcast signal received by said receiver to thereby generate the video signal; and a display unit for displaying either the video signal inputted from said video signal input terminal or the video signal generated by said demodulator; said display apparatus comprising:
compression means for compressing the video signal generated by said demodulator; and
transfer means for transferring the compressed video signal from said compression means to said another electronic appliance via a bus.

2. The display apparatus according to claim 1, further comprising expansion means for expanding the compressed video signal, wherein said expansion means expands the compressed video signal inputted from another electronic appliance via said bus.

3. The display apparatus according to claim 1, further comprising an RGB terminal for inputting an RGB video signal from said another electronic appliance.

4. The display apparatus according to claim 1, wherein said another electronic appliance is a personal computer.

5. The display apparatus according to claim 1, wherein said bus is a USB cable.

6. The display apparatus according to claim 1, wherein said bus is an IEEE1394 serial bus.

7. A display apparatus having a video signal input terminal for inputting a video signal from another electronic appliance; a receiver for receiving a broadcast signal; a demodulator for demodulating the broadcast signal received by said receiver to thereby generate the video signal; and a display unit for displaying both the video signal inputted from said video signal input terminal and the video signal generated by said demodulator; said display apparatus comprising:
compression means for compressing the video signal generated by said demodulator; and
transfer means for transferring the compressed video signal from said compression means to said another electronic appliance via a bus.

8. The display apparatus according to claim 7, further comprising expansion means for expanding the compressed video signal, wherein said expansion means expands the compressed video signal inputted from another electronic appliance via said bus.

9. The display apparatus according to claim 7, further comprising an RGB terminal for inputting an RGB video signal from said another electronic appliance.

10. The display apparatus according to claim 7, wherein said another electronic appliance is a personal computer.

11. The display apparatus according to claim 7, wherein said bus is a USB cable.

12. The display apparatus according to claim 7, wherein said bus is an IEEE1394 serial bus.

13. A display method carried out in a display apparatus which has a video signal input terminal for inputting a video signal from another electronic appliance; a receiver for receiving a broadcast signal; a demodulator for demodulating the broadcast signal received by said receiver to thereby generate the video signal; and a display unit for displaying either the video signal inputted from said video signal input terminal or the video signal generated by said demodulator; said display method comprising the steps of:
compressing the video signal generated by said demodulator; and
transferring the compressed video signal obtained at said compression step to said another electronic appliance via a bus.

14. A display method carried out in a display apparatus having a video signal input terminal for inputting a video signal from another electronic appliance; a receiver for receiving a broadcast signal; a demodulator for demodulating the broadcast signal received by said receiver to thereby generate the video signal; and a display unit for displaying both the video signal inputted from said video signal input terminal and the video signal generated by said demodulator; said display method comprising the steps of:
compressing the video signal generated by said demodulator; and
transferring the compressed video signal obtained at said compression step to said another electronic appliance via a bus.

15. A recording medium containing a program readable by a computer for controlling a display apparatus which has a video signal input terminal for inputting a video signal from another electronic appliance; a receiver for receiving a broadcast signal; a demodulator for demodulating the broadcast signal received by said receiver to thereby generate the video signal; and a display unit for displaying either the video signal inputted from said video signal input terminal or the video signal generated by said demodulator; said program comprising the steps of:
compressing the video signal generated by said demodulator; and
transferring the compressed video signal obtained at said compression step to said another electronic appliance via a bus.

16. A recording medium containing a program readable by a computer for controlling a display apparatus which has a video signal input terminal for inputting a video signal from another electronic appliance; a receiver for receiving a broadcast signal; a demodulator for demodulating the broadcast signal received by said receiver to thereby generate the video signal; and a display unit for displaying both the video signal inputted from said video signal input terminal and the video signal generated by said demodulator; said program comprising the steps of:
controlling the compression of the video signal generated by said demodulator; and
controlling the transfer of the compressed video signal obtained at said compression control step to said another electronic appliance via a bus.
